(19) United States
(12) Patent Application Publication
(10) Pub. No.: US 2006/0230768 A1
(43) Pub. Date: Oct. 19, 2006

(54) Universal defrost timer

(75) Inventors: Terry Lee Huber, Lewisburg, OH (US); Dale Thomas Rodda, Marysville, OH (US); John Hesch JR., Grove City, OH (US); Timothy William Rager, Dublin, OH (US)

Correspondence Address: REINHART BOERNER VAN DEUREN P.C., 483 NORTH MULFORD ROAD, SUITE 7, ROCKFORD, IL, 61107, US

(73) Assignee: Ranco Incorporated of Delaware, Wilmington, DE (US)

(21) Appl. No.: 11/403,427

(22) Filed: Apr. 13, 2006

Related U.S. Application Data
(60) Provisional application No. 60/671,194, filed on Apr. 14, 2005.

(51) Int. Cl. F25D 21/06; G05D 23/32; F25B 49/00

(52) U.S. Cl. 62/126; 62/151; 62/157

(57) ABSTRACT

An electronic universal defrost timer (UDT) utilizes an electronic microprocessor controlled timer that is capable of operating over a supply voltage range of 120 Volt AC to 240 Volt AC (nominal) with no customer configuration or moving of wires, jumpers, etc. is provided. The UDT provides the ability for a user to initiate a non-scheduled defrost interval at any time. Further, the UDT provides diagnostic capability to indicate miswiring or an internal fault during detected failure conditions. The UDT provides variable defrost duration times for each scheduled defrost period. The setting and indication of these defrost intervals are provided on an LCD display styled to resemble current mechanical dial faces with customer installed trippers. The UDT also resumes operation at the correct time after a power outage without requiring a user to reset the timing mechanism.

### CROSS-REFERENCE TO RELATED PATENT APPLICATIONS

This patent application claims the benefit of U.S. Provisional Patent Application No. 60/671,194, filed Apr. 14, 2005, the teachings and disclosure of which are hereby incorporated in their entireties by reference thereto.

### FIELD OF THE INVENTION

The present invention relates in general to defrost timers for use in commercial refrigeration systems, and more particularly to electronic defrost timer controls for use in commercial refrigerators to defrost the evaporator coils therein.

### BACKGROUND OF THE INVENTION

Commercial refrigerators lose efficiency when ice forms on the evaporator coils. To improve the efficiency the coils are defrosted on a periodic basis. This is accomplished by disabling the compressor and allowing or forcing the temperature of the coils to rise above the freezing temperature to remove the accumulated ice thereon.

This defrost function has been accomplished, in the past, by electromechanical timers that implemented time keeping with an AC synchronous motor clock that drove electrical contacts for the compressor and defrost means through mechanical linkages. The supply voltage requirements of the AC synchronous motor, however, dictated that separate designs or models of the timers be designed for 120 volt AC and 208˜240 AC supply voltage systems. As a result, the refrigeration service person was required to carry at least two different models for each service call, at an additional cost to him, in order to be prepared to replace which ever version of timer was installed at the customer location.

One system that attempts to overcome this dual voltage problem is described in U.S. Pat. No. 6,563,237 to Bootz, for a “Multi-Voltage electromechanical time switch”, issued May 13, 2003. This patent describes an electromechanical timer designed to operate at either 120 Volt AC or 240 Volt AC by routing the supply voltage through a resistor divider. The customer is required to adjust the position of jumpers or switches, thereby changing the resistor divider ratio, to configure the timer for either 120 Volt AC or 240 Volt AC operation. Unfortunately, a mistake by the customer during configuration of the switches/jumpers could lead to damage or destruction of the timer.

Another disadvantage with these electromechanical timers is that they typically only allow a single defrost duration time for each of the scheduled defrost periods during a day. Further, since such electromechanical timers do not include any programmed intelligence, such timers are unable to provide any diagnostic capability that may aid a service person in diagnosing and correcting a problem existing therein. Further, since such electromechanical timers operate via synchronous motor, after a power outage the customer is required to set the timer to the correct time so that the scheduled defrost periods occur at the proper time. Additionally, once the scheduled defrost periods have been setup, it is fairly difficult to attempt to initiate a non-scheduled defrost period if a user notices that the evaporator coils have developed a layer of ice that should be immediately defrosted.

There exists, therefore a need in the art for a defrost timer mechanism that will operate at both 120 Volt and 208-240 Volt AC supply voltages without requiring user intervention. There further exists a need in the art for a defrost timer that provides the ability for a customer to initiate a non-scheduled defrost period, that provides diagnostic capability and system status indication. Further, there exists a need for a defrost timer that allows for variable defrost duration times for each of the scheduled defrost periods. Further, there exists a need in the art for defrost timer that has the ability to resume operation at the correct time after a power outage without requiring the user to reset the timing mechanism.

### BRIEF SUMMARY OF THE INVENTION

In view of the above, it is an objective of the present invention to provide a new and improved universal defrost timer that overcomes the above described and other problems existing in the art. More specifically, it is an objective of the present invention to provide a new and improved universal defrost timer that utilizes an electronic microprocessor controlled timer that is capable of operating over a supply voltage range of 120 Volt AC to 240 Volt AC (nominal) with no customer configuration or moving of wires, jumpers, etc. required. Further, it is an objective of the present invention to provide a new and improved universal defrost timer that provides the ability for the customer to initiate a non-scheduled defrost interval at any time. Further, it is an objective of the present invention to provide diagnostic capability to indicate miswiring or an internal fault during detected failure conditions. Further, it is an objective of the present invention to provide system status indication to the user via a lighted display. Preferably, the universal defrost timer of the present invention also provides variable defrost duration times for each scheduled defrost period. It is also an objective of the present invention to provide a new and improved universal defrost timer that includes the ability to resume operation at the correct time after a power outage without requiring a user to reset the timing mechanism.

In an embodiment of the present invention, the universal defrost timer provides multi-voltage operation from approximately 102 Volts AC to 260 Volts AC, 60 Hertz (normally 120-240 Volts AC, 60 Hertz), and utilizes the same electrical terminals for the power input without requiring any jumpers. In a highly preferred embodiment the universal defrost timer of the present invention utilizes an analog power supply that utilizes pulse width modulation (PWM) to allow the use a single set relays over the entire voltage input supply.

In one embodiment of the present invention, the universal defrost timer utilizes a manual defrost button that allows a user to immediately initiate a preset 15 minute defrost cycle, or longer as desired by the user. In a highly preferred embodiment, the universal defrost timer also allows a user to immediately terminate a currently operating defrost cycle in either an automatic or manual mode of operation. Further, this embodiment of the present invention allows a user to clear the continuation of the program defrost cycle. That is, the universal defrost timer of the present invention allows the user to delete a programmed duration from the current time through the end of the programmed cycle.

In one embodiment of the present invention, the universal defrost timer includes a back-lit liquid crystal display (LCD). Preferably the universal defrost timer of the present invention includes diagnostic circuitry, including pin G diagnostic circuitry. Preferably, the universal defrost timer provides a status indication of the pin G diagnostic failure, but allows for normal timed operation of the defrost cycle without a temperature shut-off. In a highly preferred embodiment, the universal defrost timer prevents a compressor short cycle at both power-up and during manual operation.

In a preferred embodiment of the universal defrost timer of the present invention, a maximum defrost period, preferably 105 minutes, is provided. However, a manual 15 minute period may be added after this max defrost period as controlled by the user. Further, in a preferred embodiment of the present invention, the universal defrost timer automatically moves the start time of a programmed defrost interval so that it does not coincide back-to-back with a previous defrost cycle. Preferably, the universal defrost timer includes preprogrammed cycles based on different types of equipment and installations as may be dictated by an original equipment manufacturer, in addition to the ability to allow a user to set manual defrost periods.

In a preferred embodiment of the present invention, the universal defrost timer includes communication circuitry to allow for wired, wireless, Bluetooth, etc. communications. Such communications may be utilized to provide built-in test (BIT) fault indications to service personnel as well as allowing for remote programmability of the universal defrost time. This communication circuitry also allows for individual or network operation of the universal defrost timer of the present invention.

A preferred embodiment of the universal defrost time of the present invention allows a user to rotate, adjust the time in either direction, forward or backward, to provide programming and to initiate operation thereof. Preferably, a blinking cursor is provided to allow the user to set the time in program cycles as desired. Additionally, a preferred embodiment of the universal defrost timer of the present invention allows a manual total reset of all time and program information. Further, to allow for diagnostic testing and operation of an embodiment of the universal defrost timer of the present invention, a manual override of all programmed safeties is provided.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 illustrates a front view of the universal defrost timer (UDT) of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

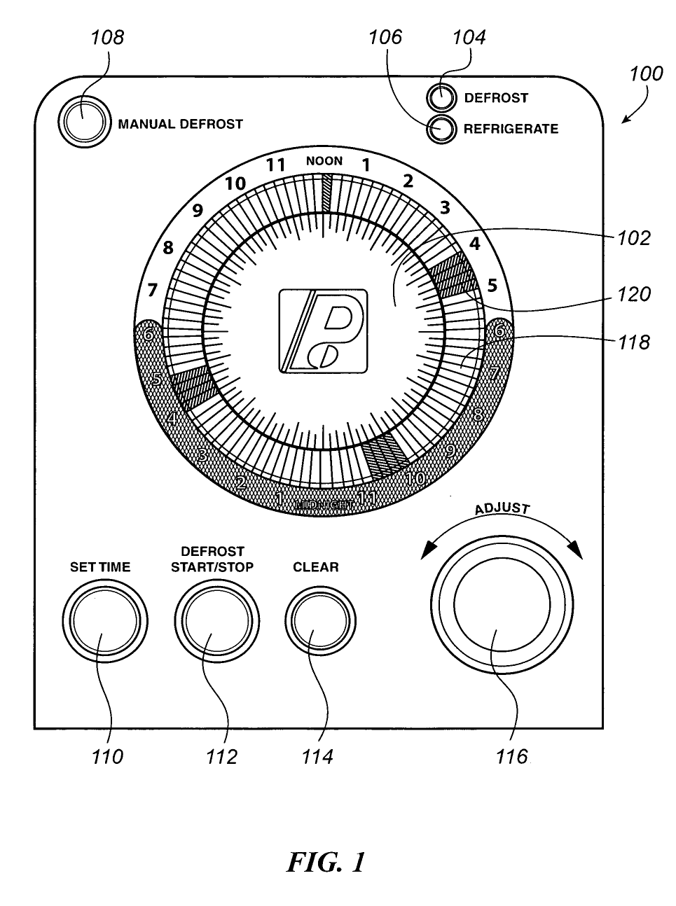

The Universal Defrost Timer (UDT) 100 of the present invention, an embodiment of which is illustrated in FIG. 1, is designed to accept power supply voltages of 120VAC, 208VAC or 240VAC directly connected to the power terminals without requiring jumpers or switches. The circuitry and method of the UDT that allows such multi-voltage operation without the requirement of a jumper or switch is described in co-pending U.S. application Ser. No. _______ , filed on even date herewith, entitled Wide Input Voltage Range Relay Drive Circuit For Universal Defrost Timer, and assigned to the assignee of the instant application, the teachings and disclosure of which are incorporated herein in their entireties by reference thereto.

As illustrated, the front face of the UDT 100 includes a backlit, dial style clock face display 102 that makes the device easy to see in dimly lit environments and is designed to mimic the look and feel of the traditional defrost time clock. The backlight is activated in one embodiment when the knob 116 or dial is turned either direction. The light shall remain on in one embodiment for one (1) minute after the adjustment knob 116 stops rotating.

Operation of the defrost cycles are controlled based on an internal real-time clock, and provides a simple defrost schedule setup. System status indicator lights 104, 106 provide positive feedback to operators and make it easy for service technicians to verify the mode of operation. A manual defrost initiation button 108 allows such an operator to initiate a manual defrost cycle or an emergency defrost. This user interface also includes a set time button 110, a defrost start/stop button 112, a clear button 114, and an adjust knob 116. The function and operation of these various elements will be described in detail below.

The Universal Defrost Timer 100 can be applied to refrigeration systems requiring regularly scheduled defrosting of the evaporator coil. Typical defrost methods that may be controlled by the UDT 100 of the present invention include off cycle, electric or hot gas. Typical applications include reach-in coolers and freezers and walk-in coolers and freezers in commercial applications such as grocery stores, convenience stores, etc. and in the foodservice (restaurant, institutional, healthcare) markets. The UDT 100 of the present invention also finds use in aftermarket applications driven by emergency service, where the service contractor is called following an equipment failure.

The illustrated embodiment of the Universal Defrost Timer 100 differs from competitive products in that it is designed to withstand the rigors of refrigeration applications. It is listed under UL standard 873 as a temperature regulating device. UL873 is much more stringent a standard than UL917 (clock operated switch) which is where typical defrost timer products are listed.

One of the advantages that the circuit and method of the present invention provides is that it allows contractors to carry a single timer on their truck to meet the requirements of most refrigeration applications. Contractors can wire the UDT 100 directly to 120VAC, 208VAC or 240VAC without the worry of correctly installing jumpers or properly positioning a switch. Indeed, this embodiment of the UDT 100 operates properly without any user configuration when subjected to the following ranges of input voltage: 102 V_{AC} min to 132 V_{AC} max; 187 V_{AC} min to 264 V_{AC} max.

By offering a single replacement model, the UDT 100 will greatly reduce the number of separate parts (SKUs) that contractors/wholesalers need to carry on a service truck, in a warehouse, and reduce the number of orders they need to place. The benefit is that the wholesaler and contractor is much more likely to have the proper product with them at time of greatest need. This reduces both the space required and the carrying charges associated with the product.

In one embodiment, the UDT 100 provides two/one single pole single throw (SPST) relays output rated as follows: 30 A Resistive @120 V_{ac} to 240 V_{ac}. 1 HP @120 V_{ac,} 2 HP @208 V_{ac} to 240 V_{ac}. An alternate embodiment of the UDT 100 provides one single pole double throw (SPDT) relay output rated as follows: 30 A Resistive @120 V_{ac} to 240 V_{ac}. 1 HP @120 V_{ac}, 2 HP @ 208 V_{ac} to 240 V_{ac}.

In the first embodiment the output relays consist of one SPST NC relay connected between two terminals, and one SPST NO relay connected between two other terminals. When the UDT 100 is in the refrigeration mode the SPST NC relay is closed and the SPST NO relay is open. When the UDT 100 enters the defrost mode, the SPST NC relay opens and the SPST NO relay closes. Preferably, time terminated defrosts are provided by this embodiment. Additional functionality, beyond that of the electromechanical defrost timers, includes the ability to initiate a fifteen minute manual defrost at any time (except during another manual defrost and subject to Short Cycle requirements), variable defrost duration times for each set defrost, and LED indicators 104, 106 that indicate when the timer is in the refrigeration or defrost cycles.

In the second embodiment, the output relays include one SPDT relay connected between three terminals, and one SPST NC relay connected between two other terminals. When the UDT is in the refrigeration mode the SPDT relay is closed between two of the terminals and the NC relay is closed between two other terminals. When the UDT enters the defrost mode the SPDT relay opens between two terminals and closes between two other terminals, and the SPST NC relay opens. Both time and temperature/pressure terminated defrosts are allowed with this embodiment. A defrost can be terminated by temperature/pressure through the use of a temperature or pressure sensing switch that connects the AC line voltage to terminal “G” when the defrost is complete. The defrost will also terminate at the programmed defrost duration time if the temperature/pressure switch has not previously terminated it.

The Universal Defrost Timer 100 was designed to mimic the look and feel of the traditional defrost time clock. Installation is simplified with the direct connect, multi-voltage capability. No jumpers or switches are required. Status indicator lights 104, 106 make it easy for service technicians to verify the mode of operation. The manual defrost button 108 allows contractors to initiate an emergency defrost. The backlit display 102 makes the device easy to see in dimly lit environments. The buttons 108, 110, 112, 114 and dial display 102 are large and widely spread.

Controlled by its internal program, the microprocessor makes periodic checks of the selected system functions, and, if some faults or a miswiring is detected, communicates those conditions to the user through the LCD display 102. The microprocessor control plus the use of custom user interface allows variable defrost duration times for each scheduled defrost. The use of low power electronics and microprocessor control allows a small super capacitor to store enough energy to maintain the correct clock time for up to 100 hours of power outage. This enables the control to resume correct operation after a power outage, of this duration or less, with no customer intervention.

Operation over the supply voltage range of 120 volt AC to 240 volt AC is implemented via a linear power supply capable of operating over this entire range as described in the co-pending application identified above. In addition, relays specified at a single DC coil drive voltage are used over this full voltage range. In order to increase power supply efficiency, these relay coils are driven by the bulk, not the regulated DC voltage from the power supply. When the AC supply voltage is at its minimum value, the bulk voltage is also at its minimum value. The specified coil drive voltage is selected to be equal to this minimum value of the bulk voltage.

The microprocessor samples the value of the bulk voltage at a periodic rate, and when the minimum value of the bulk voltage is sensed, it is applied continuously to the relay coil during the time that the relay is meant to be energized. Since the value of the bulk voltage is linearly related to the value of the AC supply voltage, the value of the bulk voltage will be more than two times the minimum value when the AC supply voltage is at its maximum value. Values of bulk voltage greater than 125% of the minimum value would typically cause the coil of the relay to fail if they were to be applied continuously. Therefore, when the microprocessor senses a bulk voltage value that could damage the relay coil, it first applies this voltage to the coil for a time period long enough to ensure that the relay energizes quickly, but not long enough to damage the relay. The bulk voltage drive to the coil is then turned on and off at a given rate, but with the correct duty cycle to produce an average value of voltage applied to the coil equal to the specified drive voltage. The applied frequency is at a high enough value that the inductance of the relay coil averages the duty cycle.

As introduced above, one embodiment of the UDT 100 of the present invention provides visual status of the current operating mode (compressor on, defrost on) using indicating lights 104, 106 or symbols (LED or similar). When the timer is in a refrigeration cycle, the microprocessor indicates this to the end user by turning on a green light emitting diode (LED) 106. A defrost cycle is indicated by a red LED 104 being activated. This will enable the service technician or end-use customer to easily and quickly assess the current operating mode of the UDT 100. The LCD display 102 preferably represents a circular analog 24-hour clock with 96 wedge shaped segments 118, each representing a fifteen minute time increment. The individual hours are designated around the edge of the clock face. A rapidly flashing segment indicates the cursor position, a slowly flashing segment indicates the clock time, and a solid segment 120 indicates a defrost time. Preferably, the display 102 utilizes black elements on silver background, transflective

In order to minimize disruption in the end-user channel, and to maintain ease-of-use, the UDT 100 has a 24-hour dial or 12-hour display 102 with an AM/PM indication, with defrost initiation and termination (if time based) “trippers” that are easily installed and adjusted. Unlike the old mechanical trippers used in prior electromechanical timers, the trippers in the present invention are digital segments that indicate a certain time period. In the displayed embodiment of FIG. 1, the trippers correspond to 15 minute periods. During each such period, the UDT 100 may operate in the refrigeration mode as indicated by an open segment 118, or in the defrost mode as indicated by a “filled in” segment 120. The more consecutive segments that are filled in, the longer the duration of the defrost cycle.

In one embodiment, a maximum of 12 defrost cycles per day is provided, although more or fewer cycles may be allowable in other embodiments. Preferably, the cycle duration is set for a minimum of 15 minutes and a maximum of 105 minutes. However, other embodiments may allow shorter and longer cycle durations as desired. A preferred setting resolution allows a defrost cycle to be initiated on two hour intervals and terminated any time between 15 and 105 minutes after the start of the cycle. However, other embodiments may use different setting resolutions. Each defrost can have its own independent defrost duration. If no defrosts are defined, the control shall only perform manual defrosts. The minimum time between programmed defrosts is 15 minutes in a preferred embodiment.

To provide operational protection for the refrigeration compressor, the UDT 100 of one embodiment includes short cycle protection. Specifically, the UDT will not allow a compressor run time shorter than five minutes, and will not allow a compressor off time shorter than thirty seconds. Additionally, to provide a back up defrost cycle termination for embodiments utilizing temperature/ pressure termination, the UDT 100 includes the capability for adjustable back-up timed termination.

Preferably, the UDT 100 offers the operator with the ability to initiate a defrost cycle manually, by pushing a button 108 or hitting a switch or other user interface (except during another manual defrost and subject to Short Cycle requirements). The microprocessor senses this actuation of a mechanical push button 108 that signifies a request for a non-scheduled defrost. The microprocessor then initiates the defrost and then terminates it after 15 minutes have elapsed. This allows the user of the UDT 100 to initiate a defrost cycle regardless of current state. At the end of the 15 minutes, the UDT shall return to its user-defined program. Other times for the manual defrost mode may be utilized as appropriate.

If manual defrost is active during the time period that a programmed defrost time is scheduled, the UDT 100 will use the earlier of the manual/programmed defrost initiation times to initiate the defrost, and the later of the manual/programmed defrost termination times as to terminate the defrost. Manual defrosts occurring before a scheduled defrost that violate the short cycle on time requirement will have the manual defrost duration lengthened to the start of the scheduled defrost. Manual defrosts occurring after a scheduled defrost that violate the short cycle off time requirement will initiate the manual defrost immediately.

In a preferred embodiment, the dial display 102 will be used to set the clock. Specifically, upon power up of the UDT 100, one segment 118 will be flashing to indicate the current time setting. The user the rotates the adjust knob 116 clockwise or counterclockwise until the flashing segment 118 corresponds to the current time. As discussed above, each segment is 15 minutes. Once the correct time is selected, the user depresses the set time button 110 to set the correct time. If the current time is not set, the clock will start keeping time from noon when AC power is applied.

Actuation of the defrost start/stop button 112 sets the defrost start or stop time to the time shown by the flashing cursor on the display 102. The first action of this button 112 after the cursor is visible is the Defrost Start setting. The cursor will be advanced by the user selected number of segments after the defrost cycle start has been selected. The action taken after the second pressing of this button 112 will be the Defrost Stop setting. If the cursor is turned off before the defrost duration is set, the defrost programming for that cycle will be cancelled.

Actuation of the clear button 114 clears the defrost shown by the flashing cursor on the display. If the cursor is at the defrost start time, the entire defrost will be cleared. If the cursor is anywhere in the defrost duration, beyond the defrost start time, the defrost will be cleared from the cursor to the end time of that defrost period.

Rotating the adjust dial 116 to the left from the center moves the display cursor around the clock dial in a counter-clockwise direction at a predetermined rate. Rotating the dial 116 to the right moves the display cursor around the clock dial in a clockwise direction at a predetermined rate. The dial 116 is implemented with an incremental encoder and therefore rotates continuously in either direction. When the user stops turning the dial 116, the cursor will turn off after predetermined time.

If Defrost Start is selected when the cursor is within a previously defined defrost period, the UDT 100 will move the new start time to after the end of the previously defined defrost allowing a 15 minute non-defrost period between them. If Defrost End is selected in a location that spans a currently defined defrost, the control shall move the new end time to before the start of the previously defined defrost allowing a 15 minute non-defrost period between them. If the current time is changed while a programmed defrost is in progress; the control will immediately switch to the new schedule while obeying the short cycle requirements.

To clear an end-user programming of the defrost cycles, an embodiment of the UDT 100 of the present invention includes a Program Rest function. When all four buttons 108, 110, 112, 114 are pressed simultaneously for 5 seconds, the UDT 100 shall “reset” or delete the end-user program. The time will reset to 12:00 pm. The manual defrost shall remain enabled in one embodiment. This reset can preferably be done without disconnecting power from the UDT.

In the event of loss of power to the UDT 100, it will maintain the real time clock and the user-defined program approximately 100 hours in a preferred embodiment for an electrical based timing source. In embodiments of the UDT that utilize a mechanical timer, the clock shall resume its user-defined program at the point power was lost (i.e. does not need to maintain real time clock) unless modified buy the user. Upon loss of input power, the timer will maintain its program, the set defrost times, and the set defrost durations for an indefinite time period. Upon loss of input power, the user interface will become inactive and the display 102 will be blank. The output relays will de-energize in one embodiment of the UDT 100.

Upon the return of AC power and the required 100-hour retention period has not expired, the UDT 100 will return to its user defined clock setting and program. Upon return of AC power and the 100 hour retention period has expired, the real time clock will return to 12:00p.m., keep it visible until the clock time has been set and start keeping time therefrom. If the user-defined program is retained, it will operate the program based upon the new time assuming that the power came back on at noon and follow the programmed defrost schedule until the clock time is reset. If, however, the program is lost for some reason, the UDT 100 will default to the refrigerate mode of operation.

In the event of a catastrophic or program failure that cannot be reset either by disconnecting the power or performing a Program Reset, all the LED segments 118 and the visual indications 104, 106 will flash at a rate of once a second in a preferred embodiment. If possible, the UDT will fail safe, default or return to the refrigerate mode of operation.

An embodiment of the UDT 100 of the present invention includes remote communication, allowing it to provide remote status and programmability. This communications may be via hard-wired connection, and/or wireless communications.

One embodiment of the UDT 100 will accept the output of a standard pressure or temperature sensitive defrost termination switch on terminal “G”. As is known, an active defrost will terminate irrespective of the set defrost duration when an AC signal of opposite polarity to that on termninal “C” is applied to this input. In embodiments that utilize such a standard pressure or temperature sensitive defrost termination switch wired to terminal “G,” the UDT 100 includes fault detection functionality to notify the service personnel or end-user of the fault. If the terminal “G” is wired directly to AC neutral, the UDT 100 will provide an indication to the service personnel or end-user. Specifically, if five minutes after power up, the controller senses that the terminal signal “G” is present and remains present, a miss-wiring of terminal “G” will be assumed and LCD segments fonning a “G” (not shown) will flash at a predetenmined rate on the display 102. The UDT 100 will thereafter revert to time only terminated defrosts because the pressure or temperature defrost termination switch is assumed to be mis-wired. Once the problem has been cleared, the control will terminate defrosts both through time and termninal “G” indications as desired.

The UDT 100 can also sense terminal “G” defrost termination switch shorted conditions. If, immediately after a scheduled defrost has initiated, the control senses that the terminal signal “G” is present and remains present, a shorted terminal “G” defrost termination switch will be assumed and LCD segments forming a “G” will flash at a predetermined rate on the display 102. The control will one again revert to time only terminated defrosts. Once the problem has been cleared, the control will terminate defrosts both through time and terminal “G” indications as desired.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A universal defrost timer (UDT), comprising:
an liquid crystal display (LCD) defining a plurality of user selectable segments thereon, each segment corresponding to a predetermined time period;
a plurality of indicators operative to provide an indication of a current mode of operation;
a rotatable user interface knob; and
a controller operatively coupled to the plurality of indicators, to the LCD to drive the plurality of segments and to the rotatable user interface knob; and
wherein the controller sequentially illuminates the plurality of segments in response to receiving input from the user interface knob indicating rotation thereof.

2. The UDT of claim 1, wherein the LCD is configured as a 24 hour clock face having the plurality of segments positioned therearound in proximity to time periods of the 24 hour clock face.

3. The UDT of claim 2, further comprising a set time user interface button operatively coupled to the controller, and wherein the controller sets a current time as a time corresponding to a currently illuminated segment upon input from the set time user interface button indicating user selection thereof.

4. The UDT of claim 3, wherein the controller advances illumination of the plurality of segments in response to passage of time of the predetermined time period to indicate the current time.

5. The UDT of claim 2, wherein the controller flashes the currently illuminated segment to indicate the current time.

6. The UDT of claim 2, further comprising at least one defrost button operatively coupled to the controller, and wherein the controller sets a start time of a defrost cycle as a time corresponding to a currently illuminated segment upon input from the defrost button indicating user selection thereof.

7. The UDT of claim 6, wherein the controller illuminates adjacent segments in response to receiving input from the user interface knob indicating rotation thereof to define a duration of the defrost cycle.

8. The UDT of claim 7, wherein the controller sets an end time of the defrost cycle as a time corresponding to a last illuminated of the adjacent segment upon input from the defrost button indicating user selection thereof.

9. The UDT of claim 8, wherein the controller initiates the defrost cycle when a current time corresponds to a start time of the defrost cycle.

10. The UDT of claim 8, wherein a minimum duration for the defrost cycle is equal to the predetenmined time period of a single segment.

11. The UDT of claim 8, wherein a minimum duration for the defrost cycle is 15 minutes and a maximum duration for the defrost cycle is 105 minutes.

12. The UDT of claim 8, further comprising a clear button, and wherein the controller erases the defrost cycle upon receipt of input from the clear button indicating user selection thereof when a current illuminated segment corresponds to the start time of the defrost cycle.

13. The UDT of claim 8, further comprising a clear button, and wherein the controller erases a remainder of the defrost cycle upon receipt of input from the clear button indicating user selection thereof when a current illuminated segment corresponds to one of the adjacent segments other than a first of the adjacent segments.

14. The UDT of claim 1, further comprising a manual defrost button operatively coupled to the controller, and wherein the controller initiates a defrost cycle for a predetermined period of time upon receipt of input from the defrost button indicating user selection thereof.

15. The UDT of claim 1, wherein the LCD is backlit at least upon receipt of input from the user interface knob indicating rotation thereof.

16. The UDT of claim 1, further comprising a plurality of user interface buttons, and wherein the controller resets defrost cycle programming upon user selection of a predetermined number of the plurality of user interface buttons for a predetenmined period of time.

17. The UDT of claim 1, wherein the controller displays a fault indication on the LCD when a terminal “G” input is sensed after a predetermined period after power up of the controller.

18. The UDT of claim 1, wherein the controller displays a fault indication on the LCD when a terminal “G” input is sensed immediately after the controller initiates a scheduled defrost cycle.

19. A universal defrost timer (UDT), comprising:
an liquid crystal display (LCD) configured as a circular analog 24-hour clock face having a plurality of illuminable segments positioned, each segment corresponding to a predetermined time period;
a controller operatively coupled to the LCD to selectively illuminate the plurality of segments to indicate at least one defrost cycle; and
wherein the controller initiates the defrost cycle when a current time corresponds with a start time of the defrost cycle.

20. The UDT of claim 19, further comprising means for user programming of the defrost cycle, and wherein the controller selectively illuminates the plurality of segments corresponding to the user programming of the defrost cycle.

21. The UDT of claim 19, further comprising a manual defrost button operatively coupled to the controller, and wherein the controller initiates a manual defrost cycle for a predetermined period of time upon receipt of input from the defrost button indicating user selection thereof.

22. The UDT of claim 19, wherein the controller selectively illuminates one of the plurality of segments corresponding to the current time.
